(19) United States
(12) Patent Application Publication
(10) Pub. No.: US 2018/0135735 A1
(43) Pub. Date: May 17, 2018

(54) ROLLER COMPONENTS

(71) Applicant: AIRBUS OPERATIONS LIMITED, Bristol (GB)

(72) Inventor: David BRAKES, Bristol (GB)

(21) Appl. No.: 15/812,165

(22) Filed: Nov. 14, 2017

(30) Foreign Application Priority Data
Nov. 14, 2016 (GB) 1619252.8

(51) Int. Cl. F16H 19/04; F16H 55/10; F16H 55/26; B64C 3/28; B64C 13/28

(52) U.S. Cl. CPC F16H 19/04; F16H 55/10; B64C 13/28; B64C 3/28; F16H 55/26

(57) ABSTRACT

A roller component configured to engage with a toothed component such that when the roller component is engaged with the toothed component, rotational movement of one of the roller component and the toothed component drives linear movement along an actuation direction of the other one of the roller component and the toothed component. The roller component includes a support member and cantilevered first rollers, each of which has a mounted end connected to a first side of the support member such that each first roller is rotatable relative to the support member about a roller axis perpendicular to the actuation direction, and an unsupported end distal from the mounted end.

### RELATED APPLICATION

This application claims priority to United Kingdom patent application GB1619252.8 filed 14 Nov. 2016, the entirety of which is incorporated by reference.

### TECHNICAL FIELD

The present invention relates to a roller component configured to engage with a toothed component such that when the roller component is engaged with the toothed component, rotational movement of one of the roller component and the toothed component drives linear movement along an actuation direction of the other one of the roller component and the toothed component. The invention further relates to a toothed component configured to engage with such a roller component, and to an aircraft wing.

### BACKGROUND

Slats (and landing gear steering systems) on aircraft are typically actuated via a rack and pinion system (spur gear). In a conventional rack and pinion system, contact surfaces on the rack and the pinion teeth slide relative to one another as the pinion teeth engage and then disengage with the rack. To prevent excessive wear or surface damage such as pitting or galling, these contact surfaces must be lubricated. Such lubrication is typically achieved by greasing the racks on an aircraft at regular intervals. The re-greasing process incurs cost and time overheads. Moreover, over time grease may build up in the local environment of the racks and attract dirt and debris.

The present invention seeks to provide a slat actuation mechanism which can reduce or avoid these disadvantages.

### SUMMARY

A first aspect of the present invention provides a roller component configured to engage with a toothed component such that when the roller component is engaged with the toothed component, rotational movement of one of the roller component and the toothed component drives linear movement along an actuation direction of the other one of the roller component and the toothed component. The roller component comprises a support member; and a plurality of cantilevered first rollers. Each of the first rollers comprises a mounted end connected to a first side of the support member such that each first roller is rotatable relative to the support member about a roller axis perpendicular to the actuation direction, and an unsupported end distal from the mounted end.

Optionally, each roller comprises a sleeve rotatably mounted on a pin. Optionally, an inner surface of the sleeve and/or an outer surface of the pin comprises a low friction coating.

Optionally, the roller component further comprises a plurality of cantilevered second rollers. Each of the second rollers may comprise a mounted end connected to a second side of the support member opposite to the first side such that each second roller is rotatable relative to the support member about a roller axis perpendicular to the actuation direction, and an unsupported end distal from the mounted end.

Optionally, the positions of the second rollers relative to the second side of the support member correspond to the positions of the first rollers relative to the first side of the support member, such that each second roller shares a common roller axis with a corresponding first roller.

Optionally, each pair of correspondingly positioned first and second rollers comprises a common pin which passes through a hole in the support member, the first roller comprising a first sleeve mounted on a first end of the pin and the second roller comprising a second sleeve mounted on a second end of the pin. Optionally, the pin is pivotably mounted to the support member, such that the angle of the roller axis relative to the support member is variable. Optionally, the pin is mounted to the support member by a spherical bearing. Optionally the pin comprises a spherical portion between two cylindrical portions, and wherein the spherical portion is pivotably mounted to the support member.

Optionally, a total width of the roller component in a direction parallel to the roller axes is substantially equal to the sum of: a width of the support member between the first and second surfaces, an axial length of a first roller, and an axial length of a second roller.

Optionally, the roller component comprises a roller pinion and the toothed component comprises a toothed rack, wherein the support member comprises a support disc arranged to rotate about a pinion axis, and wherein each roller axis is parallel to the pinion axis. Optionally, each first roller is mounted at a distance R from the pinion axis, and at distance C from each immediately adjacent first roller, wherein the values of R and C are based on the configuration of the toothed component. Optionally, the values of R and C are such that, when the roller component is in operation on the toothed component, at least two first rollers are in contact with the toothed component at all times during the operation.

Optionally, the roller component comprises a roller rack and the toothed component comprises a pinion.

A second aspect of the present invention provides a toothed component configured to engage with a roller component according to the first aspect, which comprises a plurality of cantilevered second rollers. The toothed component comprises a first set of teeth configured to engage with the plurality of first rollers, a second set of teeth configured to engage with the plurality of second rollers, and a groove between the first set of teeth and the second set of teeth configured to receive the support member.

A third aspect of the present invention provides an aircraft wing. The aircraft wing comprises a structural member; a high lift surface moveable relative to the structural member; a roller component fixed to one of the structural member and the high lift surface; and a toothed component fixed to the other one of the structural member and the high lift surface and engaged with the roller component such that rotational movement of the component fixed to the structural member drives linear movement along an actuation direction of the component fixed to the high lift surface.

Optionally, the roller component is a roller pinion fixed to the structural member, and the toothed component is a toothed rack fixed to the high lift surface. Optionally, the roller component is a roller rack fixed to the high lift surface, and the toothed component is a pinion fixed to the structural member. Optionally, the roller component is a roller component according to the first aspect. Optionally, the high lift surface is a slat and the structural member is a rib.

### BRIEF DESCRIPTION OF THE DRAWINGS

Embodiments of the invention will now be described, by way of example only, with reference to the accompanying drawings, in which:

FIG. 1 shows a schematic view of a prior art roller pinion;

FIG. 2a is a cross-section through an example roller component engaged with an example toothed component;

FIG. 2b is a schematic side-view of the example roller component and the example toothed component of FIG. 2a;

FIG. 3a is a cross-section through the roller component of FIGS. 2a-b comprising a first example self-aligning pin, engaged with the example toothed component of FIGS. 2a to b;

FIG. 3b is a cross-section through the example roller component of FIGS. 2a-b comprising a second example self-aligning pin, engaged with the example toothed component of FIGS. 2a to b;

FIG. 4a is a cross-section through an example roller component;

FIG. 4b is a schematic side-view of part of the example roller component of FIG. 3a engaged with an example toothed component;

FIGS. 5a(i) to 5a(iii) show schematic views of an example damaged roller component engaged with an example toothed component, in three different relative positions of the roller component and the toothed component;

FIGS. 5b(i) to 5b(iii) shows schematic views of an example roller component engaged with an example damaged toothed component, in three different relative positions of the roller component and the toothed component;

FIG. 6 shows a schematic view of an example aircraft slat actuation mechanism comprising a roller component;

FIG. 7a shows a schematic view of a further example aircraft slat actuation mechanism comprising a roller component; and

FIG. 7b shows a cross section through part of the aircraft slat actuation mechanism of FIG. 7b.

### DETAILED DESCRIPTION

The examples described below relate to rack and pinion systems which include roller components. The use of roller components may reduce or avoid the need to grease the example rack and pinion systems, thereby reducing maintenance overheads as compared with conventional rack and pinion systems. The example rack and pinion systems described herein are suitable for actuating slats on aircraft, including commercial airliners.

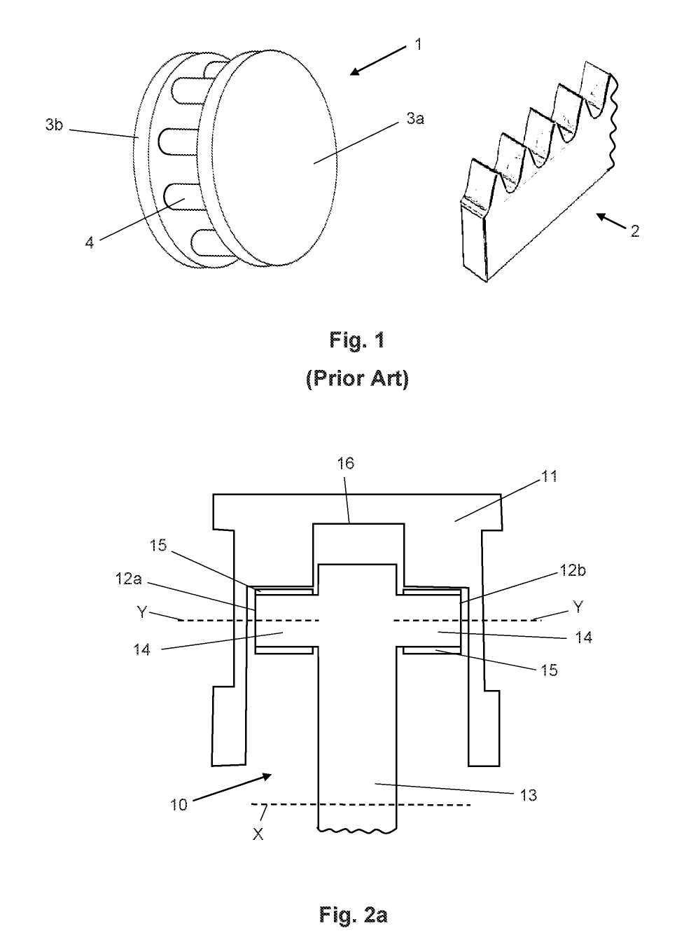

Roller pinions are used for high precision linear and rotary actuation in industrial applications such as CNC (computer numeric control) machining gantries, plasma cutting tables and automation gearheads in robotics. FIG. 1 shows a prior art roller pinion 1 and rack 2. The roller pinion 1 comprises a pair of discs 3a, 3b that support between them a circumferential series of rollers 4. The profile of the rack 2 is shaped to receive the rollers 4 such that their natural path takes them smoothly up and down the face of each tooth. In contrast to a conventional rack and pinon system (spur gear), the rollers 4 roll rather than slide down the rack teeth. As there is no relative motion between the roller surface and rack, the rack does not require lubrication.

It would be difficult to use a known roller pinion such as the one shown in FIG. 1 for actuating an aircraft slat. The space available for a slat actuation mechanism within the fixed leading edge structure of an aircraft wing is limited, meaning that the total width of the rack and pinion system (in a direction perpendicular to the actuation direction) should be as small as possible. To be useable in a slat actuation mechanism, a roller rack and pinion system needs to be no wider than conventional slat actuation rack and pinon systems. The two support discs required by the known roller pinion mean that it is difficult or impossible to create a roller pinion which is capable of handling the relatively high (as compared to the applications for which roller pinions are currently used) loads required for slat actuation (around 41kN for an Airbus A320) and which is sufficiently narrow. Furthermore, a relatively complex rack shape would need to be created on the slat track in order to accommodate the two support discs, which would be difficult and costly to achieve. The following example roller rack and pinion systems have novel structures, which enable them to handle high loads whilst having a small total width.

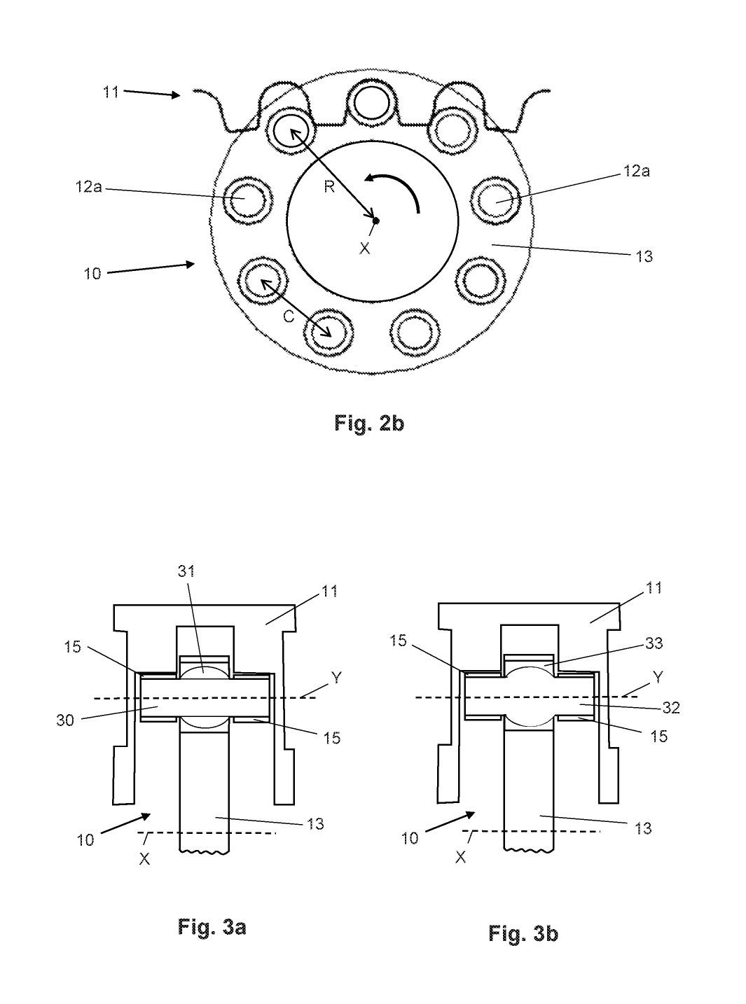

FIGS. 2a and 2b show an example roller component for use in an aircraft slat actuation mechanism. The roller component is configured to engage with a toothed component such that when the roller component is engaged with the toothed component, rotational movement of one of the roller component and the toothed component drives linear movement along an actuation direction of the other one of the roller component and the toothed component. The roller component comprises a support member and a plurality of cantilevered first rollers. Each of the first rollers comprises a mounted end connected to a first side of the support member such that each first roller is rotatable relative to the support member about a roller axis perpendicular to the actuation direction, and an unsupported end distal from the mounted end. A toothed component configured to engage with the example roller component comprises a set of teeth configured to engage with the plurality of cantilevered first rollers.

In the example of FIGS. 2a and 2b, the roller component comprises a roller pinion 10 and the toothed component comprises a toothed rack 11. The roller pinion 10 comprises a support member in the form of a support disc 13 arranged to rotate (as indicated by the arrow in FIG. 2b) about a pinion axis X. A first plurality of cantilevered rollers 12a is arranged on a first side of the support disc 13 and plurality of cantilevered second rollers 12b is arranged on a second, opposite, side of the support disc 13. The roller axis Y of each roller 12a, 12b is parallel to the pinion axis X.

The total width of the roller pinion 10 in a direction parallel to the roller axes Y (and the pinion axis X) is substantially equal to the sum of: a width of the support disc 13 between the first and second surfaces, an axial length of a first roller 12a connected to a first side of the support disc 13, and an axial length of a second roller 12b connected to a second side of the support disc 13. It is generally expected that the first rollers will have the same axial length as the second rollers, although that need not necessarily be the case. The width of the support disc may be the same as or similar to the axial length of the rollers.

The surface area of each roller depends on the diameter and on the axial length of the roller, and affects how much load the roller pinion can handle. A larger surface area enables a larger load to be reacted. However; for aircraft applications there is a limit to how large the rollers can be, as discussed above. The particular values of the above-mentioned parameters will therefore depend on the particular application of the roller pinion 10. For example, if the roller pinion is to be used in an aircraft slat actuation mechanism, these values should be such that the total width of the roller pinion fits within the slat track, and such that the roller pinion is able to handle the loads generated during slat actuation.

As can be seen from FIG. 2b, the first rollers 12a on the first side of the support disc 13 are arranged in a ring. Each first roller 12a is mounted at a distance R from the pinion axis X, and at a distance C from each immediately adjacent first roller. In the illustrated example the distances R and C are defined with respect to the roller axis of each pinion. The values of R and C are based on the configuration of the toothed component 11. In some examples the values of R and C are such that, when the roller component is in operation on the toothed component, at least two first rollers 12a (and, therefore, at least two second rollers 12b) are in contact with the toothed rack 11 at all times during the operation. Ensuring that at least two first rollers 12a are in contact with the rack 11 at all times means that the rack and pinion system experiences little or no backlash.

In the particular example the positions of the second rollers 12b relative to the second side of the support disc 13 correspond to the positions of the first rollers 12a relative to the first side of the support disc 13. As a result, each second roller 12b shares a common roller axis with a corresponding first roller 12a. Additionally, as with the first rollers 12a, each second roller 12b is mounted at the distance R from the pinion axis X, and at the distance C from each immediately adjacent second roller. Other examples are possible in which the positions of one or more of the second rollers 12b relative to the second side of the support disc 13 do not correspond to the positions of any first rollers 12a relative to the first side of the support disc 13, such that the one or more second rollers 12b are not coaxial with any first rollers 12a. Such examples may be advantageous for reducing or eliminating backlash and thus increasing the positional accuracy achievable by such example rack and pinion systems.

Each roller comprises a sleeve 15 rotatably mounted on a pin 14 (e.g. in the manner of a journal bearing). In the illustrated example, each pin 14 comprises a low friction coating (such as, e.g., Kamatics KAron or Rexnord Rexlon). This advantageously means that the rollers do not need to be greased or otherwise lubricated, and enables them to carry high loads. In some examples the inner surface of the sleeves 15 comprises a low friction coating, instead of or additionally to the pins 14 comprising a low friction coating. However; alternative examples are possible in which grease is used instead of a low friction coating, or in which each sleeve is replaced by a series of needle rollers arranged circumferentially around the pin. The pins 14 may comprise plain pins, bolts, self-aligning pins or any combination of such components. The pins 14 are fixedly connected to the support disc 13. In some examples the pins 14 may be formed integrally with the support disc 13; however, it is expected that generally the pins 14 will comprise separate components fixedly connected to the support disc 13. In some examples the pins of a pair of correspondingly positioned first and second rollers 12a, 12b are formed by a single component (e.g. a bolt, a plain pin or a self-aligning pin) which passes through a hole in the support disc 13. Advantageously, forming the pins of both rollers of a corresponding pair of rollers as a single component means that the bending moments experienced by that component are balanced during operation of the roller pinon 10. This gives the pins 14 a high strength (as compared to arrangements where individual pins are used for each roller), enabling the roller pinion 10 to handle large loads.

FIGS. 3a and 3b show examples of self-aligning pins for a roller pinion according to the invention. Use of a self-aligning pin enables the roller axis Y to vary relative to the pinion axis X. Advantageously, this ability ensures that the loading on corresponding first and second rollers will be even, in the face of manufacturing tolerances (such as rack profile tolerances) that would otherwise cause the system to favour one roller over its partner. Furthermore, self-aligning roller pins enable some misalignment between the pinion axis X and the axis of the rack to be tolerated, similar to the effect provided by crowned gear teeth. However; crowned gear teeth are not suitable for relatively high-load applications, because the crowning reduces the contact area between the rack and pinion (thus increasing the contact stress and reducing the tooth strength). This effect increases with the degree of crowning curvature (greater crowning curvature is required to compensate for larger misalignment angles). By contrast, rollers comprising self-aligning pins contact the rack teeth across the entire rack width, so the contact area and contact stress is the same as for non-self-aligning rollers. The self-aligning pins therefore provide a solution for tolerating misalignment between the rack axis and pinon axis which is suitable for high-load applications. Self-aligning roller pins are particularly advantageous for aircraft slat applications, as some slat tracks are designed to ‘swing’ laterally to compensate for wing bending effects (relative lateral displacement of slat and wing).

FIG. 3a shows a first example self-aligning pin arrangement, provided on the example rack and pinion system of FIGS. 2a and 2b. A unitary pin 30 is mounted to the support disc 13 of the pinion 10 by a spherical bearing 31. The spherical bearing 31 may be of any suitable type known in the art. The spherical bearing 31 permits pivoting of the roller axis Y about the centre point of the spherical bearing, enabling the roller axis Y to align with the rack axis even when this is not parallel to the pinion axis X. Although only one roller is visible in FIG. 3a, multiple or all of the rollers comprised in the pinion 10 may comprise a self-aligning pin of the same type as the pin 30.

FIG. 3b shows a second example self-aligning pin arrangement, provided on the example rack and pinion system of FIGS. 2a and 2b. A unitary pin 32 comprises a spherical central portion. The spherical portion of the pin 32 is mounted within an outer race 33, which may be of the same or similar design to the outer race of the spherical bearing 31 of FIG. 3a. The spherical portion of the pin 32 can pivot relative to the outer race 33, thereby permitting pivoting of the roller axis Y about the centre point of the spherical portion of the pin 32. The self-aligning pin 32 can advantageously be more space-efficient than the pin 30 and spherical bearing 31 combination of FIG. 3a. Although only one roller is visible in FIG. 3b, multiple or all of the rollers comprised in the pinion 10 may comprise a self-aligning pin of the same type as the pin 32.

Returning to FIGS. 2a and 2b, the toothed rack 11 comprises a first set of teeth configured to engage with the plurality of first rollers 12a and a second set of teeth configured to engage with the plurality of second rollers 12b. The first set of teeth are aligned with the second set of teeth when the toothed rack 11 is viewed from the side, as in FIG. 2b, such that only the first set of teeth is visible in this figure. The toothed rack 11 also comprises a groove 16 (visible in FIG. 2a but not in FIG. 2b) between the first set of teeth and the second set of teeth. The groove 16 is configured to receive part of the support disc 13. In the example of FIGS. 2a and 2b, the toothed rack is formed integrally with an aircraft slat track. This can be achieved, for example, by machining a suitable profile into the inner surface of the slat track.

Alternative examples (not illustrated) are possible in which the roller pinion does not comprise any second rollers (that is, rollers are only provided on the first side of the support disc). In all other respects the features of such example roller pinions may be as described above for the example roller pinion 10. Such “one-sided” example roller pinions may not be able to handle such high loads as the “two-sided” example described above, but could be made very narrow. One-sided roller pinions could therefore be advantageous in relatively low-load applications where space is highly constrained.

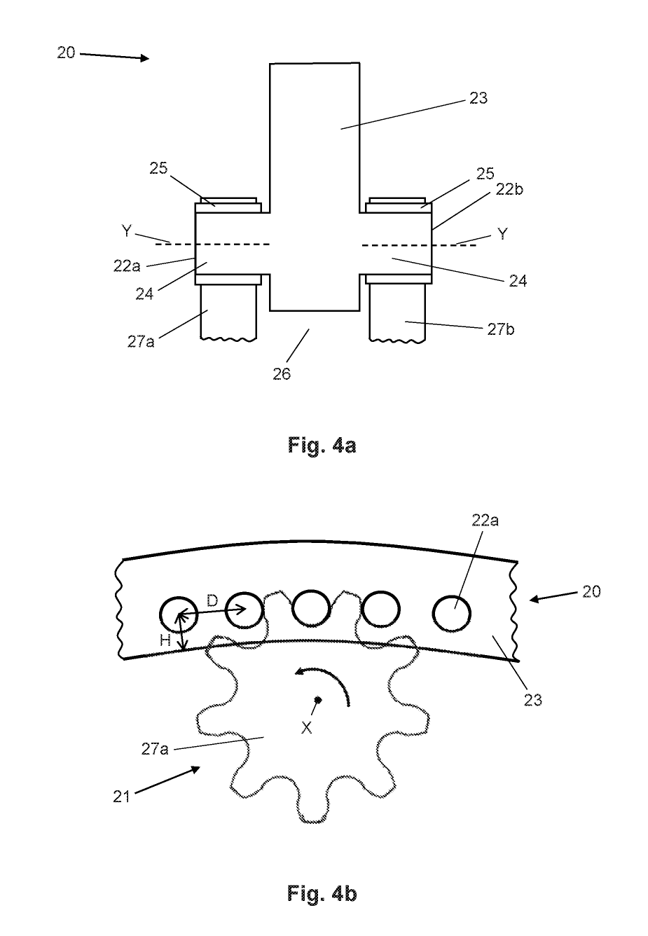

FIGS. 4a and 4b show a further example roller component configured to engage with a toothed component such that when the roller component is engaged with the toothed component, rotational movement of one of the roller component and the toothed component drives linear movement along an actuation direction of the other one of the roller component and the toothed component. Like the roller component of FIGS. 2a and 2b, the roller component of FIGS. 4a and 4b comprises a support member and a plurality of cantilevered first rollers. Each of the first rollers comprises a mounted end connected to a first side of the support member such that each first roller is rotatable relative to the support member about a roller axis perpendicular to the actuation direction, and an unsupported end distal from the mounted end. A toothed component configured to engage with the example roller component comprises a set of teeth configured to engage with the plurality of cantilevered first rollers.

In FIGS. 4a and 4b, the roller component comprises a roller rack 20 and the toothed component comprises a pinion 21 arranged to rotate (as indicated by the arrow in FIG. 3b) about a pinion axis X. The roller rack 20 comprises a support member in the form of a support beam 23. The support beam 23 may be straight or curved. In the illustrated example, the support beam is slightly curved. A plurality of first cantilevered rollers 22a is arranged on a first side of the support beam 23 and plurality of cantilevered second rollers 22b is arranged on a second, opposite, side of the support rail 23. Each roller 22a, 22b may have any or all of the same features as the rollers 12a, 12b of the roller pinion 10 described above. In some examples each roller 22a, 22b comprises a self-aligning pin, such as the self-aligning pin 30 of FIG. 3a or the self-aligning pin 32 of FIG. 3b. The roller axis Y of each roller 22a, 22b is at least substantially parallel to the pinion axis X when the roller rack 20 is engaged with the pinion 21.

The total width of the roller rack 20 (excluding the mounting member 26) in a direction parallel to the roller axes Y is substantially equal to the sum of: a width of the support beam 23 between the first and second surfaces, an axial length of a first roller 22a connected to a first side of the support beam 23, and an axial length of a second roller 22b connected to a second side of the support beam 23. The exact dimensions of the support beam 23 and the rollers 22a, 22b will be selected in dependence on the particular application for which the roller rack 20 is intended to be used.

As can be seen from FIG. 4b, the first rollers 22a on the first side of the support beam 23 are arranged in a line adjacent an edge of the support beam 23. Each first roller 22a is mounted at a distance H from a lower (with respect to the orientation shown in FIG. 4b) edge of the support beam 23, such that the line of first rollers 22a follows the curvature of the support beam 23. Each first roller 22a is mounted at a distance D from each immediately adjacent first roller. The values of H and D may be based on the configuration of the pinion 21. The values of H and D are such that, when the roller rack is in operation together with the pinion 21, at least two pinion teeth are in contact with the rack 20 at all times during the operation so that the rack and pinion system experiences little or no backlash.

The positions of the second rollers 22b relative to the second side of the support beam 23 correspond to the positions of the first rollers 22a relative to the first side of the support beam 23. As a result, each second roller 22b shares a common roller axis with a corresponding first roller 22a. As with the first rollers 22a, each second roller 12b is mounted at the distance H from the lower edge of the support beam 23, and at the distance D from each immediately adjacent second roller.

The pinion 21 comprises a first set of teeth configured to engage with the plurality of first rollers 22a and a second set of teeth configured to engage with the plurality of second rollers 22b. The first set of teeth are aligned with the second set of teeth when the pinion 21 is viewed from the side, as in FIG. 3b, such that only the first set of teeth is visible in this figure. The pinion 21 also comprises a groove or slot 26 (visible in FIG. 4a but not in FIG. 4b) between the first set of teeth and the second set of teeth. The groove 26 is configured to receive part of the support beam 23. In the example of FIGS. 4a and 4b, the pinion is formed by a first toothed wheel 27a (comprising the first set of teeth) and a second toothed wheel 27b (comprising the second set of teeth) substantially the same as the first toothed wheel 27a, each of which is mounted coaxially on a central wheel (not shown). The central wheel has a thickness equal to the width of the groove 26 and a diameter less than the diameters of the first and second pinion wheels 27a, 27b. In other examples the pinion 21 may be formed as a unitary component (e.g. it may be cast as or machined from a single piece of material).

Alternative examples (not illustrated) are possible in which the roller rack does not comprise any second rollers (that is, rollers are only provided on the first side of the support beam). In all other respects the features of such example “one-sided” roller racks may be as described above for the example roller rack 20. As with the one-sided roller pinions described above, one-sided roller racks may not be able to handle such high loads as the “two-sided” roller racks described above, but could be made very narrow. One-sided roller racks could therefore be advantageous in relatively low-load applications where space is highly constrained.

Example rack and pinion systems according to the present invention, in which either the rack or the pinion comprises a roller component, may be highly fault-tolerant and therefore very reliable. This is partly because, as discussed above, they do not require regular greasing. However, it is also because the rack and pinion can be configured such that two pinion teeth (in the case of a roller rack) or two pinion rollers (in the case of a roller pinion) are in contact with the rack at all times during operation of the rack and pinion system. As a result, the system may continue to operate if a rack tooth/roller or a pinion tooth/roller is missing or damaged. FIGS. 4a and 4b illustrate how this is achieved, for a roller pinion with a missing roller, and a rack with a damaged tooth, respectively.

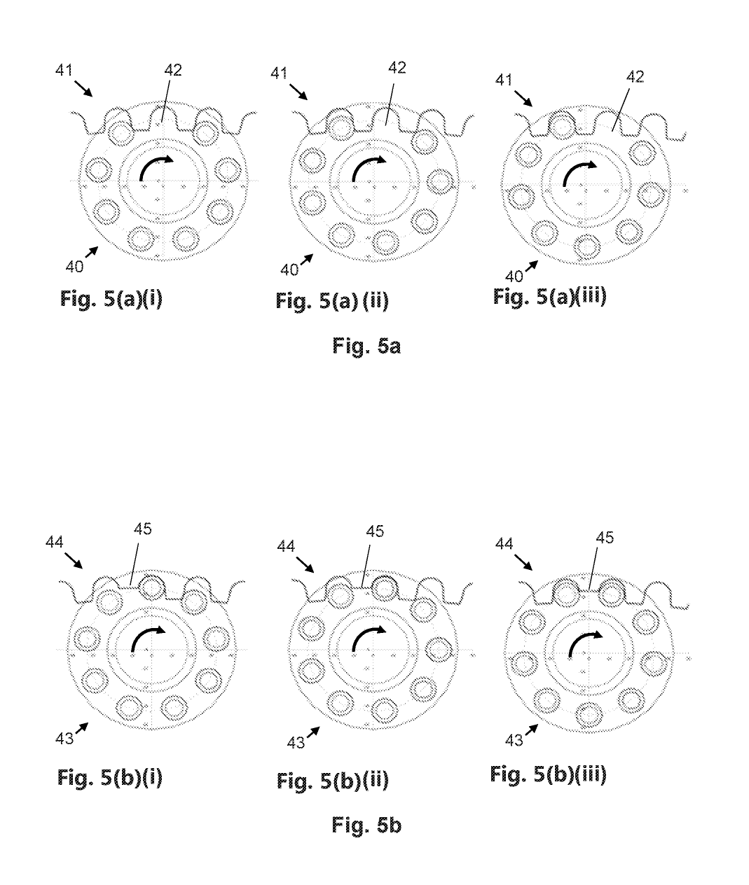

FIGS. 5(a)(i) to 5(a)(iii) show three consecutive relative positions (i), (ii) and (iii) of a clockwise-rotating roller pinion 40 with a missing roller (as indicated by the gap 42) and a toothed rack 41. The example roller pinion 40 may have any or all of the features of the example roller pinion 10 described above. In the first position (i), the missing roller would have been fully engaged with the rack 41 and would have been able to react loads in both the clockwise and anticlockwise directions. Even with this roller missing, the roller pinion 40 is still able to react both clockwise and anticlockwise loads in this position, because the forward (with respect to the rotation direction) surface of the trailing roller immediately adjacent the gap 42 is in contact with the rack, and the rearward surface of the leading roller immediately adjacent the gap 42 is in contact with the rack. In the second position (ii), both the trailing roller and the leading roller are still in contact with the rack, although the leading roller is just at the point of leaving contact. In the third position (iii) only the trailing roller is in contact with the rack. Thus it can be seen that, even as the roller pinion 40 moves through the positions in which the missing roller would have been engaged with the rack 41, at least one roller is always in contact with the rack. The ability of the roller pinion 40 to drive linear movement of the rack 41 is therefore unaffected, except that some additional backlash is introduced in position (iii) in the event of a load reversal.

FIGS. 5(b)(i) to 5b(iii) illustrates that the same principles apply in the situation in which a roller pinion 43 is engaged with a rack 44 having a damaged tooth 45. In particular, there is always a leading face of a roller in contact with an undamaged tooth at all relative positions of the rack 44 and pinion 43, so that the ability of an example roller pinion according to the invention to drive linear movement of a rack is unaffected by the loss or damage of an individual rack tooth; however there may be some additional backlash in the event of a load reversal.

It will therefore be appreciated that the ability of an example roller pinion according to the invention to drive linear movement of a rack is unaffected by the loss or damage of either an individual pinion roller or an individual rack tooth. The same is true in respect of a toothed pinion engaged with an example roller rack according to the invention.

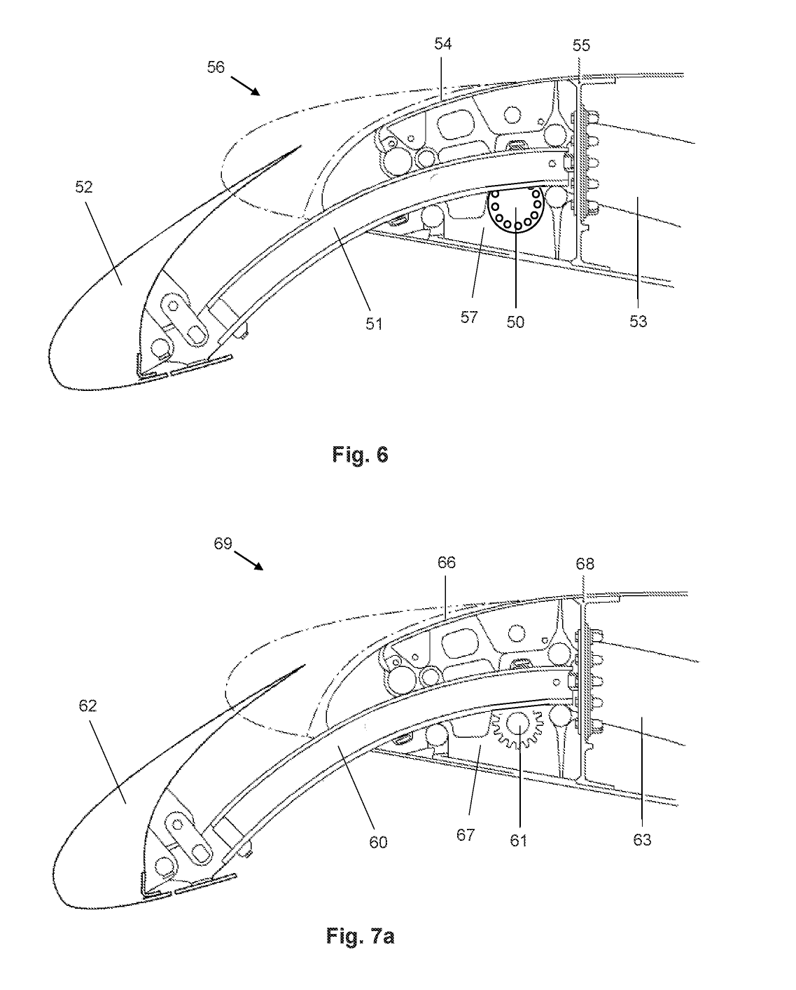

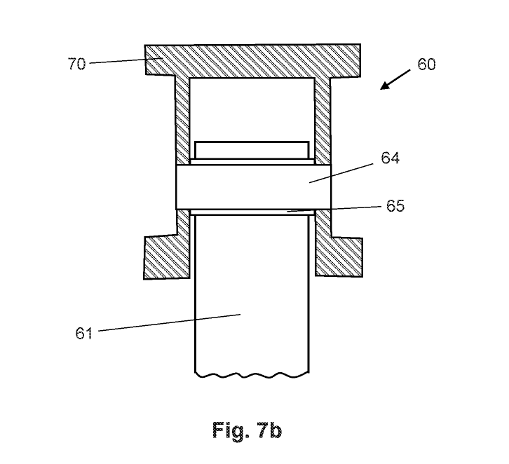

As mentioned above, example rack and pinion systems in which one of the rack and the pinion comprises a roller component may be advantageously used in aircraft high lift surface actuation mechanisms, particularly slat actuation mechanisms. The implementation of a roller component as part of a slat actuation mechanism will now be discussed in detail with reference to FIGS. 6 and 7a-b.

FIG. 6 shows an example aircraft high lift surface actuation mechanism. The actuation mechanism is comprised in an aircraft wing 56, of which only the leading edge part is shown in FIG. 6. The aircraft wing 56 comprises a structural member; a high lift surface moveable relative to the structural member; a roller component fixed to one of the structural member and the high lift surface; and a toothed component fixed to the other one of the structural member and the high lift surface and engaged with the roller component such that rotational movement of the component fixed to the structural member drives linear movement along an actuation direction of the component fixed to the high lift surface. In the illustrated example the roller component is a roller pinion 50 fixed to a rib 57, and the toothed component is a rack 51 fixed to a slat 52.

In the illustrated example, the actuation mechanism is housed in a fixed leading edge structure 54 of the wing 56, which is attached to a front spar 55 of the wing 56. The fixed leading edge structure 54 comprises a plurality of structural ribs 57 (of which only one is visible in FIG. 6) which extend forwardly from the front spar 55, including the rib 57 to which the roller pinion 50 is mounted.

As mentioned above, the example high lift surface is a slat 52. The slat 52 is configured to move between a retracted position (shown by the dashed lines in FIG. 6) and an extended position which is forward and down relative to the retracted position. Movement of the slat 52 between the retracted position and the extended position is achieved by a rack and pinion system comprising the rack 51 and the roller pinion 50. Rotation of the roller pinion 50 can be driven by any suitable drive arrangement (e.g. a motor) known in the art. Engagement between the roller pinion 50 and the rack 51 (which is machined into the slat track, for example as described above in relation to FIGS. 2a and 2b) causes rotation of the roller pinion 50 to drive linear movement of the rack 51. Clockwise rotation of the roller pinion 50 drives rearward movement of the rack 51 (and thereby retraction of the slat 52) and anticlockwise rotation of the roller pinion 50 drives forward movement of the rack 51 (and thereby extension of the slat 52). When in the retracted position, the slat track extends through an aperture in the front spar 55 and is at least partially housed within a slat track can 53 behind the front spar 55. The teeth of the rack 51 are shaped to engage with the rollers of the roller pinion 50. The engagement of the roller pinion 50 and the rack 51 may have any or all of the features of the engagement of the roller pinon 10 and the rack 11 described above in relation to FIGS. 2a-b and 4a-b.

In some examples, the roller pinion 50 is of the same type as the roller pinion 10 described above in relation to FIGS. 2a and 2b, and may have any or all of the features of that example. It is advantageous for the roller pinion 50 to be of the same type as the roller pinion 10, because of the advantages of narrowness and load capacity provided by the roller pinion 10. However; alternative examples are also possible in which the roller pinion 50 is of a conventional roller pinion design, e.g. the design shown in FIG. 1.

FIGS. 7a and 7b show a different example aircraft high lift surface actuation mechanism. The actuation mechanism is comprised in an aircraft wing 69, of which only the leading edge part is shown in FIG. 7a. As with the aircraft wing 56 of FIG. 6, the aircraft wing 69 comprises a structural member; a high lift surface moveable relative to the structural member; a roller component fixed to one of the structural member and the high lift surface; and a toothed component fixed to the other one of the structural member and the high lift surface and engaged with the roller component such that rotational movement of the component fixed to the structural member drives linear movement along an actuation direction of the component fixed to the high lift surface. In the illustrated example the roller component is a roller rack 60 fixed to a slat 62, and the toothed component is a pinion 61 fixed to a rib.

In the illustrated example, the actuation mechanism is housed in a fixed leading edge structure 66 of the wing 69, which is attached to a front spar 68 of the wing 69. The fixed leading edge structure 66 comprises a plurality of structural ribs 67 (of which only one is visible in FIG. 7a) which extend forwardly from the front spar 68, including the rib 67 to which the pinion 61 is mounted.

As mentioned above, the example high lift surface is a slat 62, which has the same features as the slat 52 described above in relation to FIG. 5. Movement of the slat 62 between the retracted position and the extended position is achieved by a rack and pinion system comprising the roller rack 60 and the pinion 61. Rotation of the pinion 61 can be driven by any suitable drive arrangement (e.g. a motor) known in the art. Engagement between the pinion 61 and the roller rack 60 causes rotation of the pinion 61 to drive linear movement of the roller rack 60 in the same manner as described above in relation to the rack and pinion system of FIG. 6. When in the retracted position, the slat track extends through an aperture in the front spar 68 and is at least partially housed within a slat track can 63 behind the front spar 68.

FIG. 7b is a cross section through an example roller rack 60 and part of an example pinion 61. In this particular example the slat track 70 supports the rollers of the roller rack 60. Each roller comprises a pin 64 which is fixedly mounted between opposite side walls of the slat track 70, and a sleeve 65 which surrounds the pin 64 and may rotate around the pin 64. The rollers of the roller rack 60 may have any or all of the same features as the rollers 12a, 12b of the roller pinion 10 or the rollers 22a, 22b of the roller rack 20 described above. The rotational axis of each roller is parallel to the rotational axis of the pinion 61. The width of the pinion 61 is such that the pinion 61 fits between the side walls of the slat track 70, and the teeth of the pinion 61 are shaped to engage with the rollers of the roller rack. The engagement of the roller rack 60 and the pinion 61 may have any or all of the features of the engagement of the roller rack 20 and the pinion 21 described above in relation to FIGS. 4a and 4b.

In other examples, the roller rack 60 may be the same type as the roller rack 20 described above in relation to FIGS. 3a and 3b, and may have any or all of the features of that example. Alternative examples are also possible in which the roller rack 60 is of a conventional roller rack design.

Although the particular examples of FIGS. 6, 7a and 7b relate to slat actuation mechanisms, other examples are possible in which the high lift surface is not a slat. For example, the high lift surface may be a flap, or any other high lift surface which can be actuated by a rack and pinion system. Moreover, the structural member need not be a rib. In alternative examples the structural member can be a front spar, a rear spar, or any other structural member of an aircraft to which a drive part of an actuation mechanism for a high lift surface can be mounted.

It should also be noted that the example roller components described above, although particularly advantageous for use in aircraft high lift surface actuation mechanisms, may also be advantageously used in various other applications which may or may not be related to aircraft. This may particularly be the case for applications in which the space available for the actuation mechanism is constrained, and/or in which the load to be handled by the actuation mechanism is relatively high.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A roller component configured to engage with a toothed component such that when the roller component is engaged with the toothed component, rotational movement of one of the roller component and the toothed component drives linear movement along an actuation direction of the other one of the roller component and the toothed component, the roller component comprising:
a support member;
a plurality of cantilevered first rollers, each comprising a mounted end connected to a first side of the support member such that each first roller is rotatable relative to the support member about a roller axis perpendicular to the actuation direction, and an unsupported end distal from the mounted end; and
a plurality of cantilevered second rollers, each comprising a mounted end connected to a second side of the support member opposite to the first side such that each second roller is rotatable relative to the support member about a roller axis perpendicular to the actuation direction, and an unsupported end distal from the mounted end,
wherein the positions of the second rollers relative to the second side of the support member correspond to the positions of the first rollers relative to the first side of the support member, such that each second roller shares a common roller axis with a corresponding first roller,
wherein each pair of correspondingly positioned first and second rollers comprises a common pin which passes through a hole in the support member, the first roller comprising a first sleeve mounted on a first end of the pin and the second roller comprising a second sleeve mounted on a second end of the pin, and
wherein the pin is pivotably mounted to the support member, such that the angle of the roller axis relative to the support member is variable.

2. The roller component according to claim 1, wherein each of the first and second rollers comprises a sleeve rotatably mounted on a pin.

3. The roller component according to claim 2, wherein an inner surface of the sleeve and/or the pin comprises a low friction coating.

4. The roller component according to claim 1, wherein the pin is mounted to the support member by a spherical bearing.

5. The roller component according to claim 1, wherein the pin comprises a spherical portion between two cylindrical portions, and wherein the spherical portion is pivotably mounted to the support member.

6. The roller component according to claim 1, wherein a total width of the roller component in a direction parallel to the roller axes is substantially equal to the sum of: a width of the support member between the first and second surfaces, an axial length of a first roller, and an axial length of a second roller.

7. The roller component according to claim 1, wherein the roller component comprises a roller pinion and the toothed component comprises a toothed rack, wherein the support member comprises a support disc arranged to rotate about a pinion axis, and wherein each roller axis is parallel to the pinion axis.

8. An arrangement comprising a roller component according to claim 7 and a toothed component to engage with the roller component, the toothed component comprising a set of teeth configured to engage with the plurality of first rollers, wherein each first roller is mounted at a distance R from the pinion axis, and at distance C from each immediately adjacent first roller, wherein the values of R and C are based on the configuration of the teeth of the toothed component.

9. The arrangement according to claim 8, wherein the values of R and C are such that, when the roller component is in operation on the toothed component, at least two first rollers are in contact with the toothed component at all times during the operation.

10. The roller component according to claim 1, wherein the roller component comprises a roller rack and the toothed component comprises a pinion.

11. A toothed component configured to engage with a roller component according to claim 1, the toothed component comprising a first set of teeth configured to engage with the plurality of first rollers, a second set of teeth configured to engage with the plurality of second rollers, and a groove between the first set of teeth and the second set of teeth configured to receive the support member.

12. An aircraft wing comprising:
a structural member;
a high lift surface moveable relative to the structural member;
a roller component according to claim 1, the roller component fixed to one of the structural member and the high lift surface; and
a toothed component fixed to the other one of the structural member and the high lift surface and engaged with the roller component such that rotational movement of the component fixed to the structural member drives linear movement along an actuation direction of the component fixed to the high lift surface.

13. The aircraft wing according to claim 12, wherein the roller component is a roller pinion fixed to the structural member, and the toothed component is a toothed rack fixed to the high lift surface.

14. The aircraft wing according to claim 12, wherein the roller component is a roller rack fixed to the high lift surface, and the toothed component is a pinion fixed to the structural member.

15. The aircraft wing according to claim 12, wherein the high lift surface is a slat and the structural member is a rib.
